(19) United States
(12) Patent Application Publication
(10) Pub. No.: US 2014/0236570 A1
(43) Pub. Date: Aug. 21, 2014

(54) EXPLOITING THE SEMANTIC WEB FOR UNSUPERVISED SPOKEN LANGUAGE UNDERSTANDING

(71) Applicant: MICROSOFT CORPORATION, Redmond, WA (US)

(72) Inventors: Larry Heck, Los Altos, CA (US); Dilek Hakkani-Tur, Los Altos, CA (US); Gokhan Tur, Los Altos, CA (US)

(73) Assignee: MICROSOFT CORPORATION, Redmond, WA (US)

(21) Appl. No.: 13/769,679

(22) Filed: Feb. 18, 2013

(51) Int. Cl. G06F 17/28

(52) U.S. Cl. CPC G06F 17/28
USPC 704/9

(57) ABSTRACT

An unsupervised training approach for Spoken Language Understanding (SLU) systems uses the structure of content sources (e.g. semantic knowledge graphs, relational databases, . . . ) to automatically specify a semantic representation for SLU. The semantic representation is used when creating entity-relation patterns that are used to mine natural language (NL) examples (e.g. NL surface forms from the web and search query click logs). The structure of the content source (e.g. semantic graph) is enriched with the mined NL examples. The NL examples and patterns may be used to automatically train SLU systems in an unsupervised manner that covers the knowledge represented in the structured content.

### BACKGROUND

Designing and training computing machines used in natural language understanding systems typically requires a large amount of human effort. Spoken Language Understanding (SLU) methods utilize supervised training patterns (e.g. in-domain patterns/utterances are collected and then the patterns are manually labeled with the true domains, intents, slots). Developers of these SLU systems spend considerable energy and time crafting each domain. Adapting spoken dialog systems for new domains and/or changes in the distribution and nature of user requests takes time and a lot of manual effort to implement.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An unsupervised training approach for Spoken Language Understanding (SLU) systems uses the structure of content sources (e.g. semantic knowledge graphs, relational databases, . . . ) to automatically specify a semantic representation for SLU. The semantic representation is used when creating entity-relation patterns that are used to mine natural language (NL) examples (e.g. NL surface forms from the web and search query click logs). The structure of the content source (e.g. semantic graph) is enriched with the mined NL examples. The NL examples and patterns may be used to automatically train SLU systems in an unsupervised manner that covers the knowledge represented in the structured content.

### BRIEF DESCRIPTION OF THE DRAWINGS

FIG. 1 shows a system for using the semantic web for leveraging structured content in a conversational understanding system;

FIG. 2 illustrates an exemplary structured web page relating to a movie;

FIG. 3 shows an example RDF segment;

FIG. 4 shows a semantically structured knowledge-base in graph form;

FIGS. 5 and 6 illustrate a process for leveraging structured content for natural language processing;

FIG. 7 shows example search results using queries formed using structured content;

FIG. 8 shows a dependency parse of a sentence;

FIG. 9 illustrates example Detection Error Tradeoff curves;

FIG. 10 illustrates an exemplary system leveraging structured content for natural language processing; and

FIGS. 11, 12A, 12B, and 13 and the associated descriptions provide a discussion of a variety of operating environments in which embodiments of the invention may be practiced.

### DETAILED DESCRIPTION

Referring now to the drawings, in which like numerals represent like elements, various embodiment will be described.

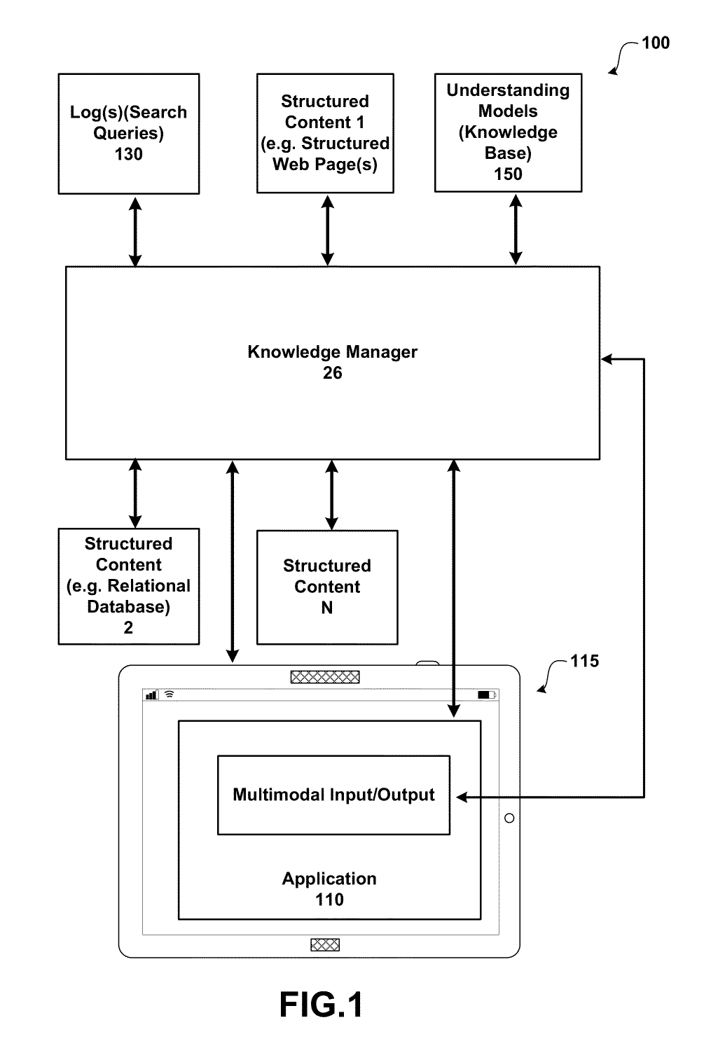

FIG. 1 shows a system for using the semantic web for leveraging structured content in a conversational understanding system. As illustrated, system 100 includes knowledge manager 26, log(s)(search queries) 130, understanding model(s) 150, structured content 1-N, application 110 and touch screen input device/display 115.

In order to facilitate communication with the knowledge manager 26, one or more callback routines, may be implemented. According to one embodiment, application program 110 is a multimodal application that is configured to receive speech input and input from a touch-sensitive input device 115 and/or other input devices. For example, voice input, keyboard input (e.g. a physical keyboard and/or SIP), video based input, and the like. Application program 110 may also provide multimodal output (e.g. speech, graphics, vibrations, sounds, . . . ). Knowledge manager 26 may provide information to/from application 110 in response to user input (e.g. speech/gesture). For example, a user may say a phrase to identify a task to perform by application 110 (e.g. selecting a movie, buying an item, identifying a product, . . . ). Gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device/display 115 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

A natural user interface (NUI) and/or some other interfaces may be used to interact with a system. For example, a combination of a natural language dialog and other non-verbal modalities of expressing intent (gestures, touch, gaze, images/videos, spoken prosody, etc.) may be used to interact with the application/service. Knowledge manager 26 may use an understanding model (e.g. a Spoken Language Understanding (SLU) model and/or multimodal understanding model such as understanding models (knowledge base)150). Knowledge manager 26 may be part of a dialog system that receives speech utterances and is configured to extract the meaning conveyed by a received utterance.

Generally, Natural Language Understanding (NLU) in goal-oriented dialog systems is directed at identifying the domain(s) and intent(s) of the user, as expressed in natural language (NL), and to extract associated arguments or slots. For example, in an airline domain, users often request flight information (e.g. “I want to fly to Boston from New York next week”). In many instances the slots are specific to the target domain and finding target values within automatically recognized spoken utterances can be challenging due to automatic speech recognition errors and poor modeling of natural language variability. Different classification methods may be used for filling frame slots from the application domain using a given training data set and performed comparative experiments. These methods generally use generative models such as hidden Markov models, discriminative classification methods and probabilistic context free grammars.

Some NLU models may be trained using supervised machine learning methods. These models use a large number of in-domain sentences which are semantically annotated by humans. This can be a very expensive and time consuming process. Additionally, NLU models use in-domain gazetteers (such as city, movie, actor, or restaurant names) for better generalization. Populating and maintaining these gazetteers, which are typically very dynamic and need constant maintenance and use a significant amount of manual labor.

Knowledge manager 26 is configured to access structured content (e.g. structured content 1-N) that includes related entities (e.g. structured web pages, relational database(s), . . . ). The structured content that is accessed may be based on a type of information to learn. For example, movie web site(s) may be accessed for information relating to a movie domain, music web site(s) may be accessed for information relating to a music domain, sport web site(s) may be accessed for information relating to a sport domain, and the like.

Traditional training of SLU systems uses queries that are manually labeled (domain, intent, and slots). This supervised training limits the breadth of the SLU semantic coverage. Leveraging the enriched structured content (e.g. semantic graphs) SLU labels may be automatically inferred on training data. This training data may be used to train SLU systems in an unsupervised manner.

Generally, knowledge manager 26 is configured to train in an automatic and unsupervised manner a Spoken Language Understanding (SLU) systems using structured content. Knowledge manager 26 uses the structure of content sources (e.g. semantic knowledge graphs, relational databases, . . . ) to automatically specify a semantic representation for SLU. The semantic representation is used when creating entity-relation patterns that are used to mine natural language (NL) examples (e.g. NL surface forms from the web and search query click logs). Knowledge manager 26 enriches the structure of the content source (e.g. semantic graph) with the mined NL examples and patterns determined from the NL examples. The NL examples and patterns may be used to automatically train SLU systems in an unsupervised manner that covers the knowledge represented in the structured content.

Given the breadth of available structured content (e.g. semantic graphs such as Freebase), the coverage of domains, intents, and slots of an SLU system may be greatly extended automatically and unsupervised. For example, each branch of a semantic graph provides additional coverage for an SLU system, and knowledge manager 26 may crawl through the graph until the structured content is traversed. When a new structured content source becomes available, knowledge manager 26 can learn the new knowledge automatically. The natural language patterns that are frequently used when realizing the relation of entity pairs may be determined and these patterns can then be used to generate or mine additional training data or as features for machine learning. More details are provided below.

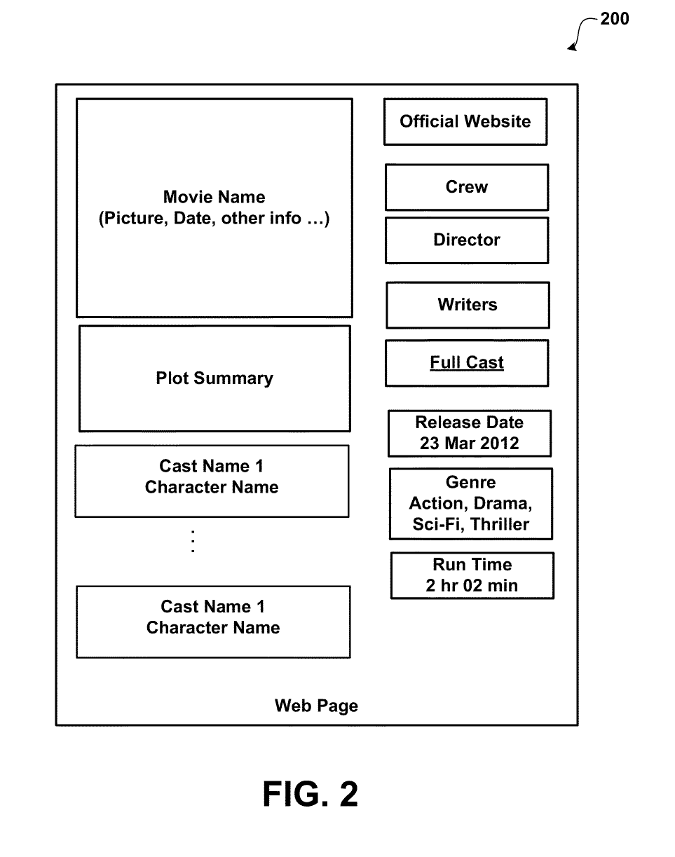

FIG. 2 illustrates an exemplary structured web page relating to a movie. One or more web pages may be associated with a movie. The information associated with a web page may change depending on the web site being accessed. For example, some web sites include different information. In the example illustrated, web page 200 includes information related to the movie name, a plot summary, cast names, crew names (e.g. director, writers), other crew (e.g. Full Cast), the release date, the genre, and run-time. Information for other domains may be learned using other structured web pages.

A Resource Description Framework (RDF) may be used that is a triple-based representation for the semantic web. A triple typically consists of two entities linked by some relation. An example would be directed by (Avatar, James Cameron). As RDFs have become more popular, triple stores (referred as knowledge-bases) covering various domains have emerged (e.g. freebase.org). Already defined ontologies may be extended or elements within one ontology may be used within another ontology. A commonly used ontology is provided in schema.org, with consensus from academia and major search companies like MICROSOFT and GOOGLE. While the structured content is illustrated within structured web pages, other structured content may be used (e.g. relational database(s)).

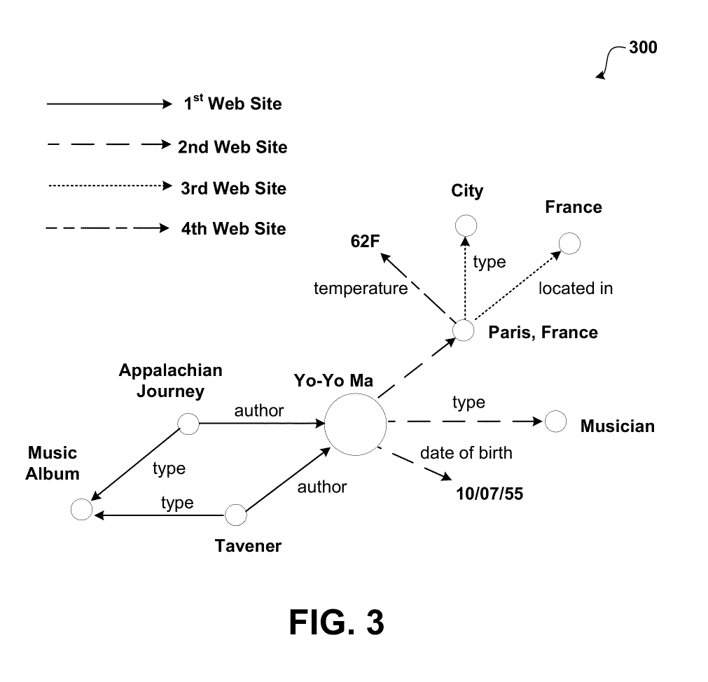

An example RDF segment pertaining the artist Yo-Yo Ma is shown in FIG. 3. Viewing FIG. 3 is can be seen that Yo-Yo was born in Paris in 1955, and is an author of the music albums, Tavener and Appalachian Journey. The RDF segment illustrated in FIG. 3 includes information obtained from different web sites (e.g. web sites 1-4). These semantic ontologies are not only used by search engines, which try to semantically parse them, but also by the authors of these pages for better visibility. These kinds semantic ontologies are similar to the semantic ontologies used in goal-oriented natural dialog systems.

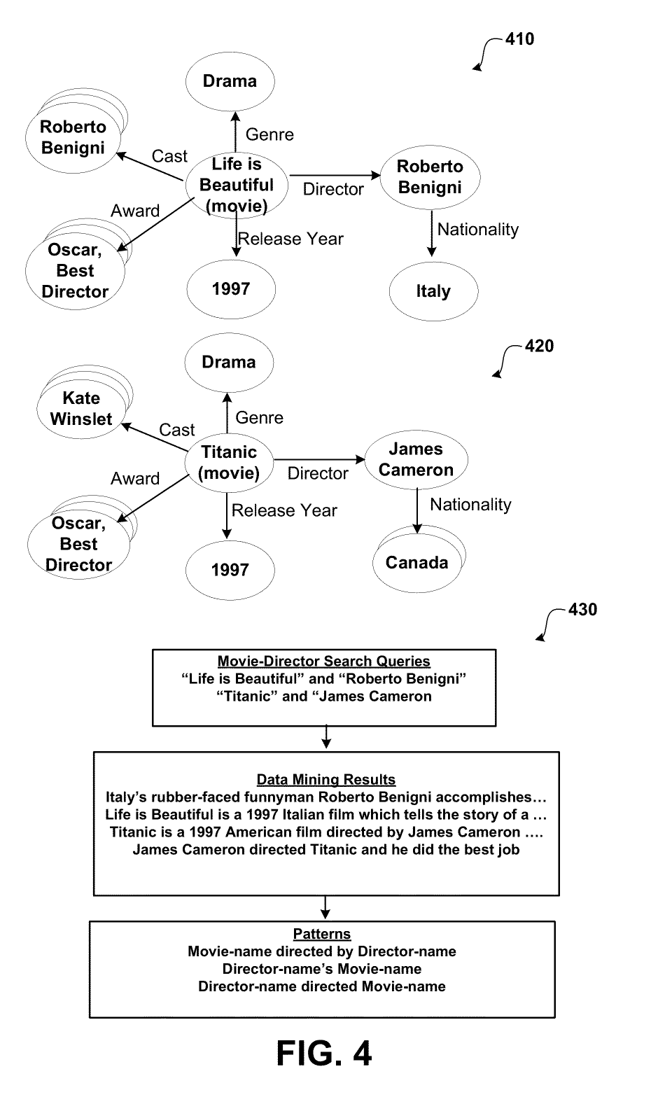

FIG. 4 shows a semantically structured knowledge-base in graph form.

Structured content sources (e.g. from the web or some other location) include entities (e.g., movies, organizations, restaurants, etc.) and their relations (e.g., director, founder, menu).

As illustrated, FIG. 4 includes branch 410 for the movie “Life is Beautiful” and branch 420 for the movie “Titanic.” The entities in the graphs are related to the other entities through links. For example, the genre for the “Life is Beautiful” entity is “Drama.”

Natural Language (NL) examples (e.g. NL surface forms) are mined and are used to enrich the structured content. These NL examples may also be used to train statistical models in SLU systems and/or use them for other NL processing.

Table 1 illustrates example surface forms.

| Entity | Relation | Entity | NL Surface form |
|---|---|---|---|
| COMPANY | Founder | PERSON | COMPANY is founded |
| | | | by PERSON, |
| | | | founder of COMPANY |
| | | | Who is the founder |
| | | | of COMPANY |
| | | | Which company is |
| | | | PERSON a founder |
| MOVIE-NAME | Director | PERSON | MOVIE-NAME directed |
| | | | by PERSON |
| | | | PERSON's MOVIE- |
| | | | NAME |
| | | | The critically acclaimed |
| | | | movie MOVIE-NAME |
| | | | directed by PERSON |

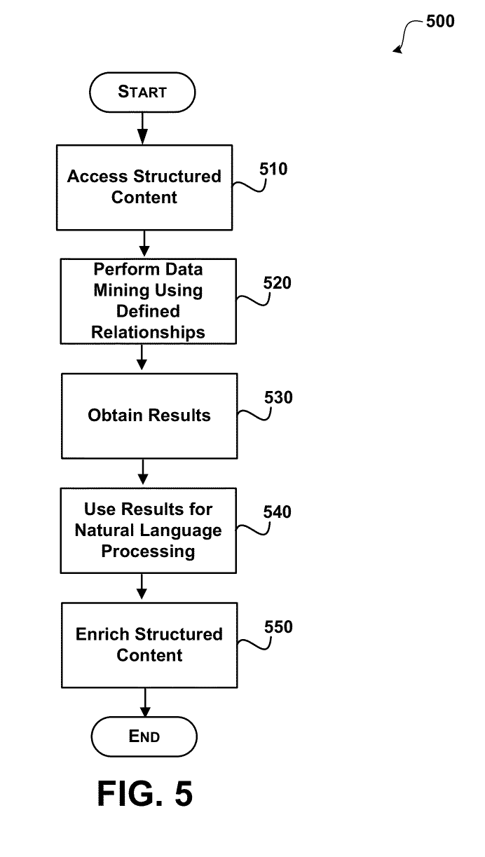

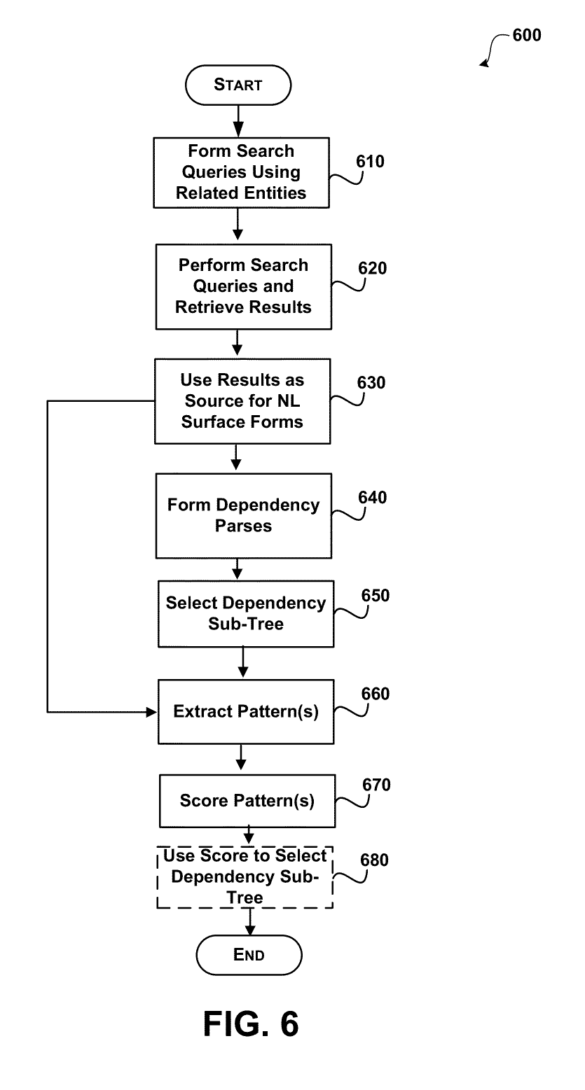

FIGS. 5 and 6 illustrate a process for leveraging structured content for natural language processing. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 5 shows a process 500 for enriching structured content used in a natural language processing.

After a start operation, the process moves to operation 510, where structured content is accessed. The structured content comprises entities that are defined by a relationship (e.g. entity-relationship-entity, entity-relationship-entity-relationship-entity, . . . ). The structured content may be in one or more forms (e.g. structured graph, structured web pages, relational databases, and the like). According to an embodiment, the structured content is structured web pages. The structured content that is accessed may be based on a type of information to learn. For example, movie web site(s) may be accessed for information relating to a movie domain, music web site(s) may be accessed for information relating to a music domain, sport web site(s) may be accessed for information relating to a sport domain, and the like. The structured content follows one or more patterns (e.g. depending on the structured content accessed) According to an embodiment, a knowledge-graph (e.g. such as FREEBASE) may be accessed to obtain structured information. Generally, these web sites structure data relating to different topics/entities that each have a unique identifier. For example, FREEBASE currently comprises almost 23 million entities. The nodes of the knowledge graphs are entities (person, place, or thing). The edges of the graph are relations between the entities.

Transitioning to operation 520, data mining is automatically performed using related entities determined from the structured content. For example, queries may be formed based on the defined relationships (e.g. in a structured web page a query that includes two related entities may be joined to form the query). Two or more related entities may be included within a query and/or used in the data mining. Queries may be formed for a portion/all of the structured content. For example, queries may be formed for each defined relationship or a portion of the defined relationships within the structured content. According to an embodiment, web queries that are formed are executed by a web search engine (e.g. BING, GOOGLE, and the like).

Moving to operation 530, the results from the data mining are obtained. According to an embodiment, search results are obtained from a search engine. The results may be automatically filtered. Since there may be a large number of results, one or more filters may be used to obtain representative results that are used to enrich the structured content. These filters may be used to eliminate results which do not meet predetermined criteria (e.g. each entity word is within some predetermined distance within a result, the result is in a natural language form, and the like). Patterns may also be determined using the results (See FIG. 6 and related discussion).

Flowing to operation 540, the results are used for a natural language system. For example, the results may be used to generate and/or mine additional training data and/or as features for machine learning. Patterns may be determined from the results and used for enhancing the data for known intents as well as creating data for unknown intents.

Moving to operation 550, the structured content is enriched using the results from the data mining and/or any models trained using the results.

The process then flows to an end operation and returns to processing other actions.

FIG. 6 shows an exemplary process for leveraging structured web data for natural language processing.

After a start operation, the process moves to operation 610, where search queries are automatically formed. Given an entity in the knowledge structure (e.g. graph), web search queries are formed through a conjunction with related entities. For example, the entity “Life is Beautiful” (a movie) within structure 410 is related to the entity “Roberto Benigni” (a director). Joining these two related entities forms the search query is “Life is Beautiful” and “Roberto Benigni”. Display 430 shows an example of movie-director search queries formed using structured data from graph 410 and graph 420. Forming the search queries continues for the all/portion of the rest of the knowledge structure.

Moving to operation 620, the search queries are performed and search results are received using the formed search queries. According to an embodiment, a predetermined number of search results are used (e.g. the top-N most relevant documents received and ranked from a standard search engine (e.g., BING, GOOGLE). Other ranking may be used in combination/separate from the received results. Search results may also be obtained from other search engines.

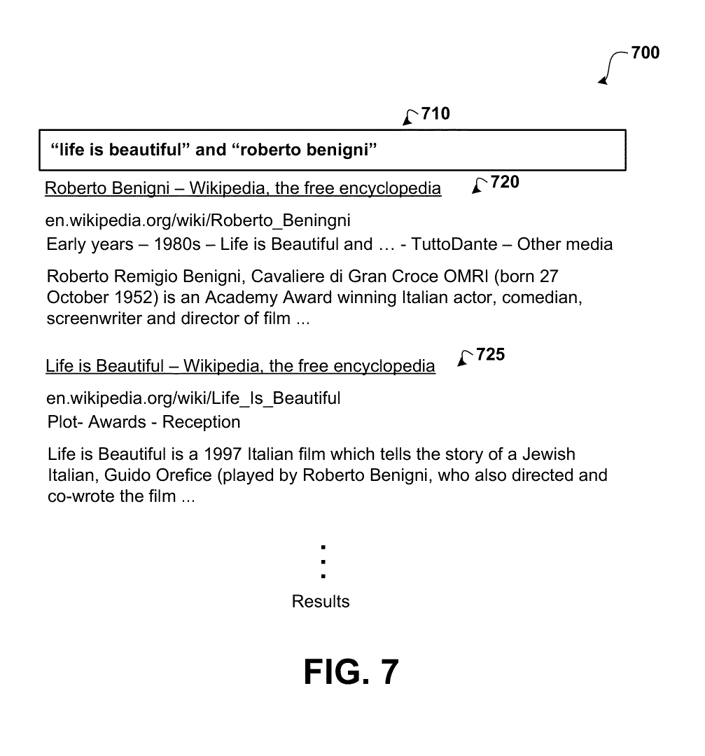

Transitioning to operation 630, the obtained results are used as the source of NL surface forms. According to an embodiment, the summarized captions or snippets (e.g. 720 and 725 in FIG. 7) of the retrieved documents on the search results page are used as the source of NL surface forms. According to another embodiment, the results obtained from following the corresponding links on the search page are used. From operation 630, the process may flow to either operation 640 or operation 660. When the operation moves to operation 660, patterns may be extracted from snippets without using dependency parses.

Flowing to operation 640, the results are analyzed using syntactic/linguistic analysis. According to an embodiment, the results are parsed using the Berkeley Parser trained from a Treebank following a latent variable approach by iteratively splitting nonterminals is used for parsing. According to an embodiment, the LTH Constituency-to-Dependency Conversion toolkit (http://nlp.cs.lth.se/software/treebank converter) is used to form dependency parses from the output parse trees. Other parsing methods and/or syntactic/linguistic analysis may be used (e.g. constituency parser, . . . ).

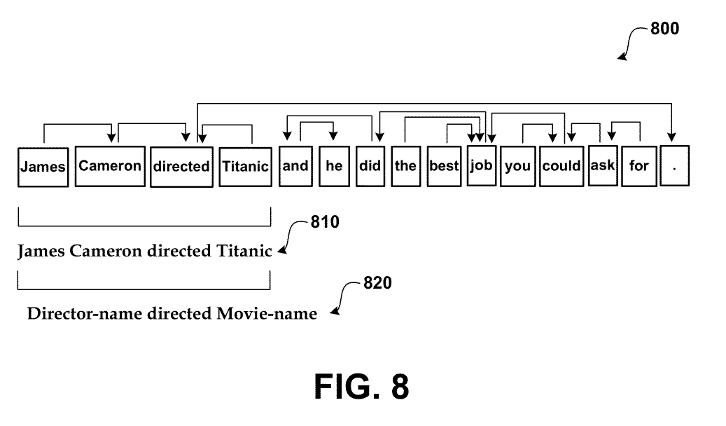

Moving to operation 650, once the returned results from the search are dependency parsed, a dependency sub-tree (e.g. the smallest) that includes the two entities of the branch on the semantic graph is selected. For example, FIG. 8 shows a dependency parse of the sentence (800) “James Cameron directed Titanic and he did the best job you could ask for.” FIG. 8 also shows the word sequence 810 corresponding to the smallest sub-tree including the two entities James Cameron and Titanic.

Flowing to operation 660, a pattern is extracted from the sub-tree using the knowledge structure. For example, referring to FIG. 4 it can be seen that the “James Cameron” of entity is the Director-name, and the entity (“Titanic”) is the Movie-name. The candidate pattern 830 from sentence 810 is obtained by replacing these entities with their entity tokens.

Transitioning to operation 670, a score for each pattern is computed. After the patterns are extracted using their dependency parses, a score, s(p), for each pattern, p, is computed using the following equation: s(p)=P(rel₁|p)−P(rel₂|p) where P(relᵢ|p) is the probability of the i^{th} most probable relation given the pattern.

Moving to optional operation 680, the score is used in automatically determining the patterns that are distinguishing for the specific type of entity relation. According to an embodiment, the patterns with highest scores are assigned to their most probable relations.

The process then moves to an end operation and returns to processing other actions.

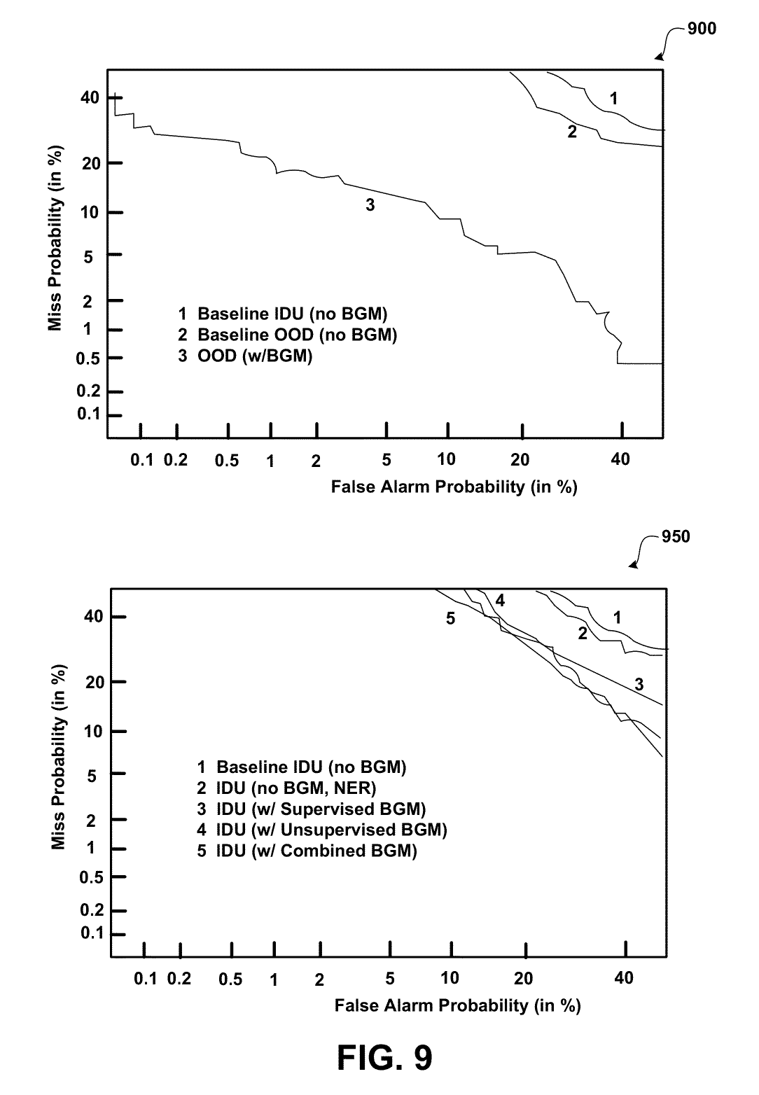

FIG. 9 illustrates example Detection Error Tradeoff curves.

The following description is an example in the business domain and is provided for illustration purposes and is not intended to be limiting. Example queries for 10 known intent classes of the business domain used in the example are shown in Table 2.

| Query | Intent |
|---|---|
| “create a list of the top ten banks by employees” | Find Company (General) |
| “what is the price of your common preferred and adjustable stock” | Find Stock Information |
| “show how much money was spent by Microsoft on advertising” | Find Finances |
| “what are analysts saying about investing in the Coca Cola company stock” | Find News |
| “can you tell me about the sales revenue from the last quarter” | Find Revenue |
| “which cell phone model had the largest number of complaints in 2011” | Find Products |
| “show the highest paid tech CEO and his salary versus company revenue” | Find Leadership |
| “chart Apple's sales for last year” | Find Annual Sales |
| “show me any history and info on the treasurer of Dell” | Find People |
| “find me all the overseas offices for Apple and rank them by highest | Find People |
| market cap then by liabilities” | |

In the current example, twenty seven other intents are defined to represent unknown classes. Separate intent classes are trained for the 10 known target intent classes shown in Table 2, and a single background model (BGM) is trained in an unsupervised manner to represent the remaining unknown non-target classes. The training data for the intent models consists of 4,032 queries distributed across the 10 known intent classes of Table 2, with the Find Company (General) class having the most tokens (35.8%) and Find Location having the least (3.1%). For each set of models, ICSIBOOST is used to discriminatively train the intent detector. In the current example, the detectors use bigram features and are trained with 1000 Boosting iterations with a default smoothing value of 0.5. The test data for the IDU detection experiments consists of 899 queries covering both the 10 known intent classes as well as the other (unknown) 27 intents. The distribution of queries over the known intent classes in the test data was approximately the same as the training data.

Each query for both training and testing was processed with a named-entity recognizer (NER). The NER used a multi-pass, longest string match method against a large collection of entities from MICROSOFT BING's enriched version of structured content (e.g. freebase.org) using the process as described herein.

Referring to the intent detection cost measure in the following Equation (C=Cₘᵢₛₛ*P_{Tgt}*Pₘᵢₛₛ|T_{gt}+C_{fa}*P_{NonTgt}*P_{fa|NonTgt}), the prior probability of the known, target intent class P_{Tgt} and unknown intent P_{NonTgt} as well as the cost of errors Cₘᵢₛₛ and C_{fa} determine the operating point on the system's performance DET curve. For illustration, the entire DET curves are illustrated in FIG. 9. The portion of the DET curve that may be relevant for many applications is the upper left (lower P_{fa|NonTgt}) portion. This results since a false accept typically leads to the system taking an erroneous action, whereas a miss simply generates a reprompt. To highlight this region of the DET curve, the P_{miss|Tgt} is computed for low P_{fa|NonTgt} for each curve.

Referring to DET curve 900 in FIG. 9, the upper right DET curve (1) with the highest error rates is the baseline IDU system trained over the 10 known intent classes with no background model.

The out-of-domain (OOD) detector's performance is the second curve from the upper right (2). For purposes of comparison, the same system was used for both the OOD and in-domain unknown (IDU) detectors with different test sets. For the OOD system, a test set uses 3,627 queries from the Movies domain (e.g., “when is the second season of vampire diaries coming out”), along with the same set of in-domain queries as the IDU test. The equal-error rates (EER), or the operating point where the two detection errors are equal, and the P_{miss|Tgt} at P_{fa|NonTgt}=10% for the two tasks are shown in Table 3. As can be seen, the OOD performance is consistently better (lower detection error) across the operating points as compared to the IDU system. The EER drops from 36.5% of the IDU detector to 31.3%, and the Pₘᵢₛₛ@Pfa=10% drops by 29.8% (rel.) from 73.4% to 51.5%.

TABLE 3
Comparison of OOD and IDU intent detection

| | EER | Pₘᵢₛₛ@Pfa = 10% |
|---|---|---|
| Baseline IDU (no BGM) | 36.5% | 73.4% |
| Baseline OOD (no BGM) | 31.3% | 51.5% |
| OOD (w/BGM) | 9.5% | 9.1% |

For comparison to OOD systems reported in the literature, results on an OOD detector are included with a background model (BGM). The BGM was trained with 4,732 queries from the other domains (Hotels, Restaurants). Example OOD queries from this testset include “four star affordable suites of america that have a separate reading area” and “find the phone number of bamboo garden bellevue”. With the BGM, the EER drops to 9.5%.

Given the relative complexity of IDU detection and importance for commercial conversational understanding systems, and the ease of building an effective OOD detector, the primary focus of this pa per is IDU detection. With the increased ambiguity of in-domain but unknown intent classes, higher precision training queries for the BGM may be used.

Display 950 of FIG. 9 and Table 4 compare four systems: a Baseline IDU detector with no BGM (same baseline as the IDU vs OOD experiments above), a Baseline IDU detector trained with queries processed by the named-entity recognizer as described above, and two IDU detectors with BGMs trained with and without supervised intent class labels. For the unsupervised training, 23,561 NL surface forms were used from the enriched semantic graphs. These were produced with the procedure described herein. The number of retrieved search results (and associated captions) used was N=10.

Example queries for the Find Founder intent class are shown in Table 1. For the supervised training of the BGM, hand-crafted queries were used, following the same procedure used to create the training queries.

| | EER | Pₘᵢₛₛ@Pfa = 10% |
|---|---|---|
| Baseline IDU (no BGM) | 36.5% | 73.4% |
| (no BGM, Named Entity Recognition) | 35.1% | 72.2% |
| IDU (w/Supervised BGM) | 26.4% | 54.3% |
| IDU (w/Supervised BGM) | 27% | 53.5% |
| IDU (w/Combined BGM) | 25.2% | 47.8% |

As can be seen, the performance of the unsupervised semantic graph-based method developed in this paper approximately matches the performance of the supervised training in the EER and upper left (low P_{fa}) regions of the DET curve. The unsupervised method's EER is 27.0% compared with 26.4% for supervised, and 53.5% at Pₘᵢₛₛ@Pfa=10% for unsupervised training, compared with 54.3% for supervised. The unsupervised EER is 26% better (rel.) than the baseline, and it is not significantly different than supervised (z-test). The supervised BGM does, however, perform significantly better in the high P_{fa} (low Pₘᵢₛₛ) region of the curve. When the supervised and unsupervised training data is combined, the resulting system improves, with an EER of 25.2% and the Pₘᵢₛₛ@Pfa=10% is 47.8%, which is 34.9% better (rel.) than the baseline and significantly better than either the supervised or unsupervised BGM.

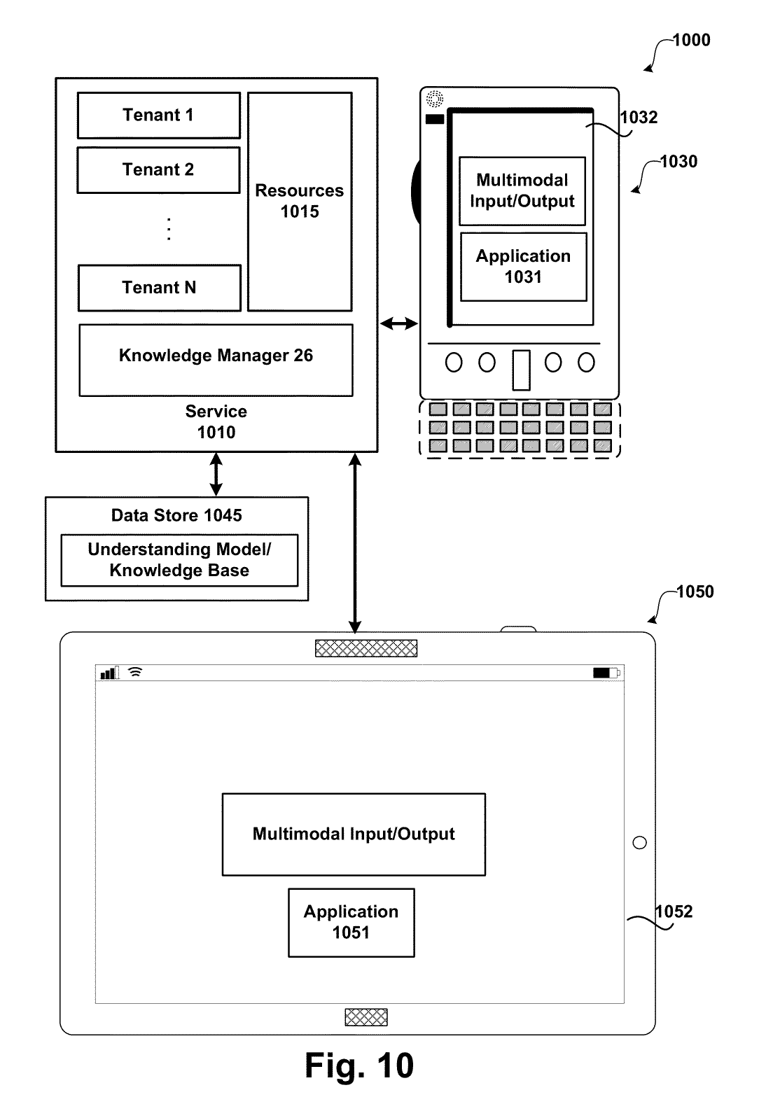

FIG. 10 illustrates an exemplary system leveraging structured content for natural language processing. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as multimodal services related to various applications (e.g. games, browsing, locating, productivity services (e.g. spreadsheets, documents, presentations, charts, messages, and the like)). The service may be interacted with using different types of input/output. For example, a user may use speech input, touch input, hardware based input, and the like. The service may provide speech output that combines pre-recorded speech and synthesized speech. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with multimodal applications and each include a an application (1031, 1051).

As illustrated, touch screen input device/display 1050 and smart phone 1030 shows exemplary displays 1052/1032 showing the use of an application using multimodal input/output. Data may be stored on a device (e.g. smart phone 1030, slate 1050 and/or at some other location (e.g. network data store 1045). Data store 1054 may be used to store the central knowledge base. The applications used by the devices may be client based applications, server based applications, cloud based applications and/or some combination.

Knowledge manager 26 is configured to perform operations relating to leveraging structured content as described herein. While manager 26 is shown within service 1010, the functionality of the manager may be included in other locations (e.g. on smart phone 1030 and/or slate device 1050).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

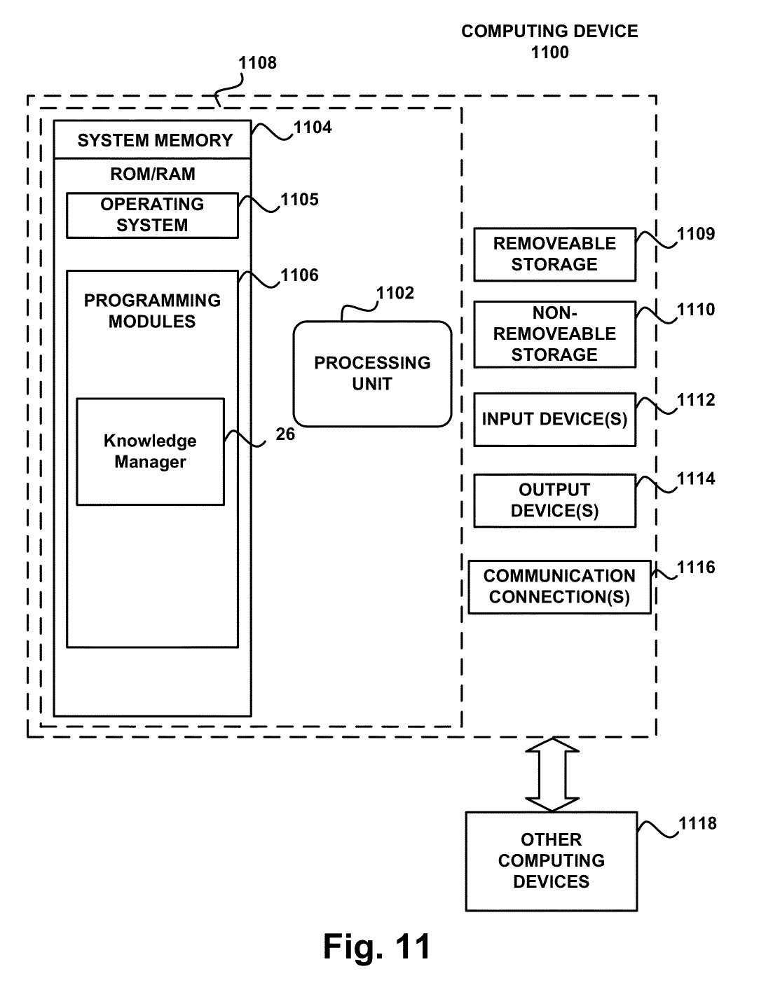

FIGS. 11-13 and the associated descriptions provide a discussion of a variety of operating environments in which embodiments of the invention may be practiced. However, the devices and systems illustrated and discussed with respect to FIGS. 11-13 are for purposes of example and illustration and are not limiting of a vast number of computing device configurations that may be utilized for practicing embodiments of the invention, described herein.

FIG. 11 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a knowledge manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to methods as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

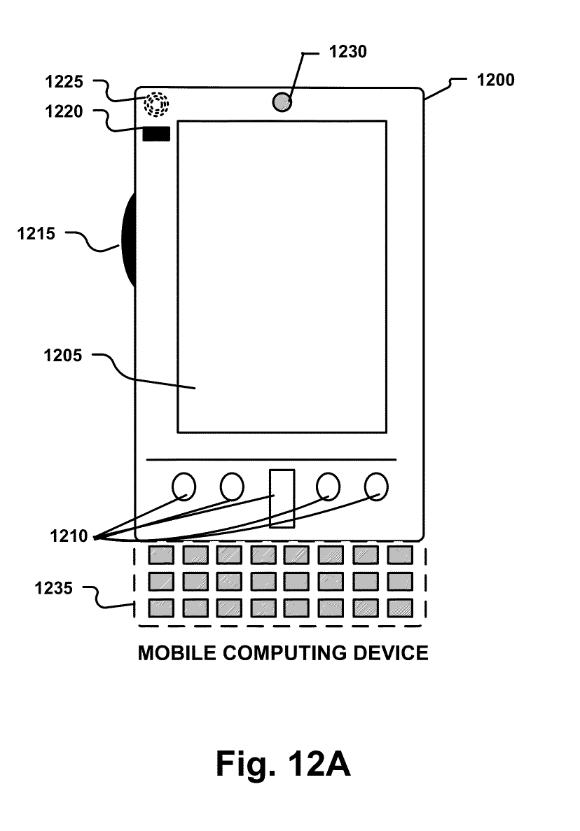

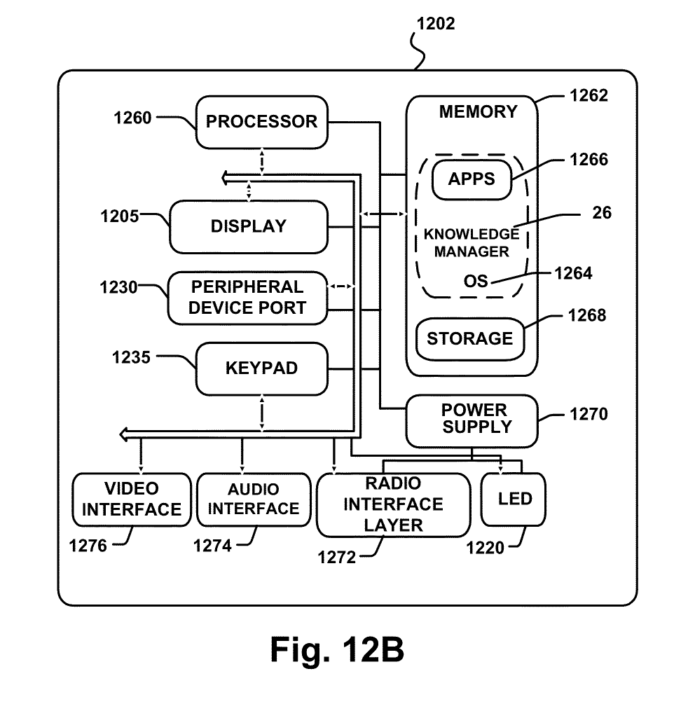

FIGS. 12A and 12B illustrate a suitable mobile computing environment, for example, a mobile telephone, a smartphone, a tablet personal computer, a laptop computer, and the like, with which embodiments of the invention may be practiced. With reference to FIG. 12A, an example mobile computing device 1200 for implementing the embodiments is illustrated. In a basic configuration, mobile computing device 1200 is a handheld computer having both input elements and output elements. Input elements may include touch screen display 1205 and input buttons 1210 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1210. Mobile computing device 1200 may also include an optional keypad 1235. Optional keypad 1235 may be a physical keypad or a “soft” keypad generated on the touch screen display.

Mobile computing device 1200 incorporates output elements, such as display 1205, which can display a graphical user interface (GUI). Other output elements include speaker 1225 and LED 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 12B is a block diagram illustrating components of a mobile computing device used in one embodiment, such as the computing device shown in FIG. 12A. That is, mobile computing device 1200 can incorporate system 1202 to implement some embodiments. For example, system 1202 can be used in implementing a “smart phone” that can run one or more applications similar to those of a desktop or notebook computer such as, for example, presentation applications, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 1262 and run on or in association with operating system 1264. Examples of application programs include phone dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the knowledge manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone to receive audible input, such as to facilitate a telephone conversation. In accordance with embodiments of the present invention, the microphone may also serve as an audio sensor to facilitate control of notifications. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 8B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

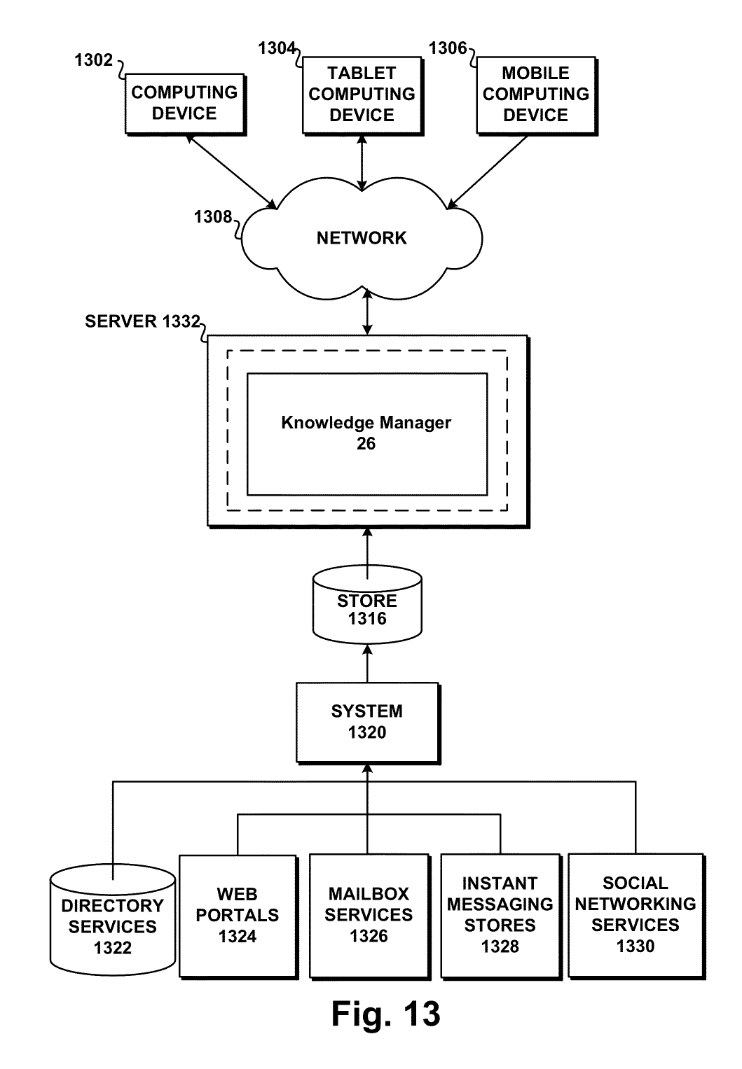

FIG. 13 illustrates an exemplary system architecture.

Components managed via the knowledge manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to using and determining variations. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for extracting natural language examples for natural language processing, comprising:
accessing structured content that includes related entities having defined relationships;
automatically performing data mining using at least a portion of the related entities within the structured content;
obtaining results from the data mining; and
automatically enriching the structured content by associating the results with at least the portion of the related entities.

2. The method of claim 1, wherein automatically performing the data mining using the at least a portion of the related entities within the structured content comprises forming queries using at least two related entities within the structured content and executing the query against a data source.

3. The method of claim 1, wherein automatically performing the data mining using the at least a portion of the related entities within the structured content comprises forming web queries using at least two related entities within the structured content and executing the web query using a search engine.

4. The method of claim 3, further comprising using summarized captions returned by the search engine as a source of Natural Language Surface forms.

5. The method of claim 1, wherein accessing the structured content comprises accessing at least one of: a structured graph and a relational database.

6. The method of claim 1, further comprising forming dependency parses using the results from the data mining and selecting a dependency sub-tree that includes each of the related entities.

7. The method of claim 1, further comprising determining a pattern from the results and substituting each entity with an entity type.

8. The method of claim 1, further comprising using the results to enhance data for known intents and create data for unknown intents.

9. The method of claim 1, further comprising determining patterns from the results, scoring each of the patterns and selecting patterns based on the score.

10. A computer-readable medium storing computer-executable instructions for extracting natural language examples for natural language processing, comprising:
accessing structured content that includes related entities having defined relationships using at least one of: at least one of: a structured graph and a relational database;
automatically performing data mining using at least a portion of the related entities within the structured content;
obtaining results from the data mining; and
automatically enriching the structured content by associating the results with at least the portion of the related entities.

11. The computer-readable medium of claim 10, wherein automatically performing the data mining using the at least a portion of the related entities within the structured content comprises forming queries using at least two related entities within the structured content and executing the query against at least one data source.

12. The computer-readable medium of claim 10, wherein automatically performing the data mining using the at least a portion of the related entities within the structured content comprises forming web queries using at least two related entities within the structured content and executing the web query using a search engine.

13. The computer-readable medium of claim 12, further comprising using summarized captions returned by the search engine as a source of Natural Language Surface forms.

14. The computer-readable medium of claim 10, further comprising forming dependency parses using the results from the data mining and selecting a dependency sub-tree that includes each of the related entities for each of the results.

15. The computer-readable medium of claim 14, further comprising determining a pattern from the results and substituting each entity with an entity type.

16. The computer-readable medium of claim 10, further comprising using the results to train models for known intents and unknown intents.

17. A system or extracting natural language examples for natural language processing, comprising:
a processor and memory;
an operating environment executing using the processor; and
a knowledge manager that is configured to perform actions comprising:
accessing structured web pages;
accessing structured content that includes related entities having defined relationships using at least one of: at least one of: a structured graph and a relational database;
automatically performing data mining using at least a portion of the related entities within the structured content;
obtaining results from the data mining; and
automatically enriching the structured content by associating the results with at least the portion of the related entities.

18. The system of claim 17, wherein automatically performing the data mining using the at least a portion of the related entities within the structured content comprises forming queries using at least two related entities within the structured content and executing the query against at least one data source.

19. The system of claim 17, wherein automatically performing the data mining using the at least a portion of the related entities within the structured content comprises forming web queries using at least two related entities within the structured content and executing the web query using a search engine.

20. The system of claim 17, further comprising forming dependency parses using the results from the data mining and selecting a dependency sub-tree that includes each of the related entities for each of the results.
